(19) United States
(12) Patent Application Publication
(10) Pub. No.: US 2024/0037102 A1
(43) Pub. Date: Feb. 1, 2024

(54) METHOD AND APPARATUS FOR SECURING DATABASES

(71) Applicant: MOTOROLA SOLUTIONS, INC., CHICAGO, IL (US)

(72) Inventors: WOEI CHYUAN TAN, BAYAN LEPAS (MY); MOH LIM SIM, BAYAN LEPAS (MY); KIN HEE WOO, GELANG PATAH (MY); CARMEN JIA YI SIAU, KOTA KINABALU (MY)

(21) Appl. No.: 17/816,452

(22) Filed: Aug. 1, 2022

(51) Int. Cl. G06F 16/2455; G06F 16/9535; H04L 51/224

(52) U.S. Cl. CPC G06F 16/2455; G06F 16/9535; H04L 51/224

(57) ABSTRACT

A method and apparatus for better securing databases is provided herein. During a database search, a target of a search (e.g., a person or object) will have a maximum number of allowed searches. When a user performs a search on a target, a determination of how many prior searches on the target object or individual was made. If the number of prior searches exceeds a threshold, then the search will be denied.

### BACKGROUND OF THE INVENTION

Private workplace databases can be abused for personal purposes. For example, an investigation by the Detroit Free Press, showed that a database available to Michigan public servants was used to help individuals stalk people, threaten motorists after traffic altercations, and track estranged spouses. It would be beneficial if private databases could be better secured to prevent such abuse.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram of an apparatus used to secure a database.

FIG. 2 is a flow chart showing operation of the apparatus of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for better securing databases is provided herein. During a database search, a target of a search (e.g., a person or object) will have a maximum number of allowed searches. When a user performs a search on a target, a determination of how many prior searches on the target object or individual was made. If the number of prior searches exceeds a threshold, then the search will be denied.

Once a search is denied, an indication of the denial may be sent to a supervisor (e.g., via email). The report may include details such as relevancy of search subject to the searcher's assignment, the relationship between the searcher and subject being searched, . . . , etc.

In one embodiment of the present invention, a user may be allowed to search on a target even if the maximum number of allowed searches for the target has been reached. For example, if a current assignment or investigation assigned to a detective has various targets associated with it, then those targets may be allowed to be searched by the detective, even if the maximum number of searches for the targets has been reached.

In another embodiment of the present invention, the maximum number of allowed searches for any target may be based on whether or not the target is a subject of an investigation or recent incident. For example, if a police report showed that a blue Ford pickup truck was involved in a hit and run accident, then all blue Ford pickup trucks may have their maximum number of allowed searches increased (e.g., increased by one).

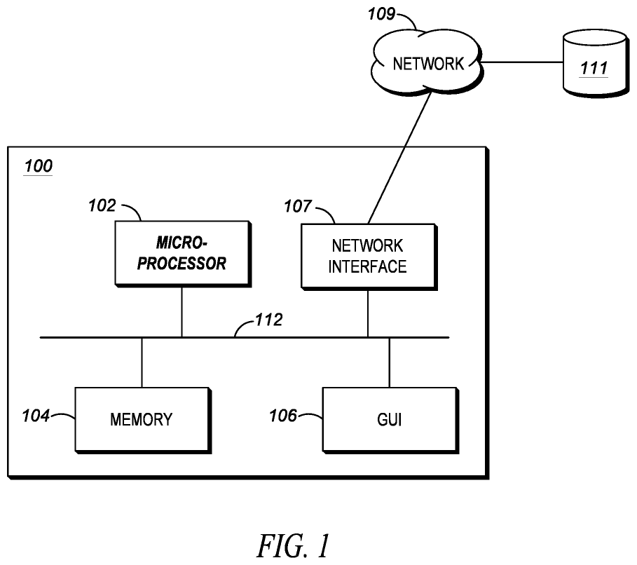

Turning now to the drawings, wherein like numerals designate like components, FIG. 1 is a block diagram of apparatus 100 utilized for performing database searches. In various examples, apparatus 100 may comprise a computer, a mobile telephone, a smart phone, or any device capable of performing a search of a database. Apparatus 100 is also capable of executing instructions (sequential or otherwise) that specify actions to be taken by the apparatus.

Apparatus 100 may include various components connected by bus 212. Apparatus 100 may include a hardware processor (logic circuitry) 102 such as one or more central processing units (CPUs) or other processing circuitry able to provide any of the functionality described herein when running instructions. Processor 102 may be connected to a memory 104 that may include a non-transitory machine-readable medium on which is stored one or more sets of instructions. Memory 104 may include one or more of static or dynamic storage, or removable or non-removable storage, for example. A machine-readable medium may include any medium that is capable of storing, encoding, or carrying instructions for execution by processor 102, such as solid-state memories, magnetic media, and optical media. Machine-readable medium may include, for example, Electrically Programmable Read-Only Memory (EPROM), Random Access Memory (RAM), or flash memory.

The instructions may enable apparatus 100 to operate in any manner thus programmed, such as the functionality described specifically herein, when processor 102 executes the instructions. The machine-readable medium may be stored as a single medium or in multiple media, in a centralized or distributed manner. In some embodiments, instructions may further be transmitted or received over a communications network via a network interface 107 utilizing any one of a number of transfer protocols (e.g., frame relay, internet protocol (IP), transmission control protocol (TCP), user datagram protocol (UDP), hypertext transfer protocol (HTTP), etc.).

Network interface 107 may thus enable apparatus 100 to communicate with database 111 through network 109 in order to search video and data stored in database 111. Network interface 107 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which apparatus 100 may be connected via network interface 107 may include a local area network (LAN), a wide area network (WAN), a packet data network (e.g., the Internet), mobile telephone networks (e.g., cellular networks), and wireless data networks.

Apparatus 100 may further include one or more graphical user interfaces (GUIs) 106 for performing a search of database 111. GUI 106 provides a man/machine interface for receiving an input from a user (e.g., a query) and displaying information (e.g., search results). For example, GUI 106 may provide a way of conveying (e.g., displaying) information received from database 111. Part of this information may comprise search results. In order to provide the above features (and additional features), GUI 106 may comprise any combination of a touch screen, a computer screen, a keyboard, or any other interface needed to receive a user input and provide information to the user.

Finally, database 111 is similar to memory 104, and is utilized to store information, such as, but not limited to audio, video, databases, drivers license information, license plate information, location information for vehicles, . . . , etc. For example, database 111 may be utilized to store video camera data, which may be searched for any number of objects or people. For example, video data may be searched for individuals (e.g., Jim Doe), or may be searched for particular license plates (e.g., IL 23332). Regardless of what is stored in database 111, GUI 106 provides database 111 with a search query (e.g., search a particular video for license plate IL 23332, search a particular database for Jane Doe, search a particular video for Jim Smith, . . . , request for information on vehicles associated with a particular license plate, . . . , etc.). It should be noted that although database 111 is shown existing external to apparatus 100, database 111 may exist internal to apparatus 100 as part of memory 104.

As discussed above, private workplace databases can be abused for personal purposes. In order to better secure database 111, logic circuitry 102 will only allow a predetermined number of searches for a particular object or person from GUIs 106. For example, searching anything in database 111 for “John Doe” may be limited to three searches, searching anything in database 111 for “IL 23332” may be limited to eight searches, . . . , etc. In other words, logic circuitry 102 will determine a subject of a search query. A database (see table 1 below) will be accessed to determine a number of prior searches for the subject that were conducted. If the number exceeds a threshold, the search is not allowed. If the number does not exceed the threshold, the search is allowed, and the number of prior searches in increased by 1.

TABLE 1
searched objects and their allowed number
of searches and number of searches.

| | | | People | |
|---|---|---|---|---|
| | | Number | excluded | person to |
| Searched | Number of | of | from | notify when |
| Object or | Searches | Searches | search | target search |
| Person | Allowed | Conducted | restrictions | is restricted |
| John Doe | 5 | 0 | | joe@abc.com |
| License Plate | 8 | 8 | Bill Smith | fred@abc.com |
| IL 23332 | | | | |
| . . . | . . . | . . . | . . . | . . . |

It should be noted that in one embodiment of the present invention, the number of searches conducted can be reset to zero, or decremented by a predetermined number after a predetermined period of time. So, for example, after 6 months of no activity (i.e., no searches conducted on an object or person), an object or person will have their number of past searches conducted reduced to zero.

It should also be noted that certain individuals may be excluded from any search restrictions. For example, as shown in Table 1, Bill Smith has been excluded from any search restrictions for license plate IL 23332. Certain individuals may be excluded based on factors such as, but not limited to supervisory approval for exclusion, whether or not an individual is part of an active investigation involving the target, . . . , etc. Thus, because Bill Smith is involved in an active investigation in which the vehicle with license plate IL 23332 is involved, Bill Smith may be excluded from any search restrictions for the target. It should also be noted that in one embodiment of the present invention, a search for license plate IL 23332 by Bill Smith will not increase the number of searches conducted on license plate IL 23332. Thus, in one embodiment of the present invention, people excluded from search restrictions will not have the number of searches conducted incremented for targets that they are excluded from search restrictions for.

Table 1 may also comprise information on a person to notify when a target is restricted for searching. So, for example, if a person searches for information on John Doe, and the search is restricted because a maximum number of searches has been executed, Table 1 indicates that joe@abc.com will be notified of the restriction (by logic circuitry 102 sending the email). The person who was restricted may also be provided the email contact. It should be noted that while Table 1 shows email addresses for contact information, any contact information (such as phone) numbers may be utilized.

Thus, as described, apparatus 100 comprises graphical user interface 106 configured to output a search query having a target of the query. Logic circuitry 102 is provided and configured to receive the search query and the target of the query, determine a number of past searches for the target of the query, determine a maximum number of searches for the target of the query, and prevent a database search for the target of the query when the number of past searches exceeds the maximum number.

Apparatus 100 also comprises database/memory 104 comprising the number of past searches for the target of the query, and the maximum number of searches for the target of the query. Logic circuitry 102 may be configured to determine the number of past searches for the target of the query and the maximum number of searches for the target of the query by accessing the database.

As discussed above, database 104 may also comprise a list of individuals excluded from any search restrictions and/or a list of contacts for each target, wherein the contacts are notified when a search for the target is prevented. Logic circuitry 102 can then determine the contact for target of the query when the search on the target is prevented, and send an email or text message to the contact when the database search has been prevented for the target of the query.

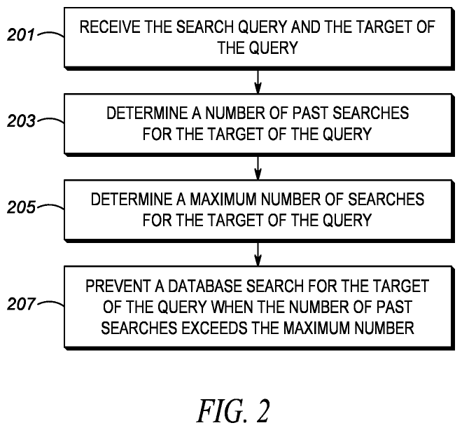

FIG. 2 is a flow chart showing operation of apparatus 100. The logic flow begins at step 201 where logic circuitry 102 receives a search query and a target of a query and determines a number of past searches for the target of the query (step 203). At step 205, logic circuitry 102 determines a maximum number of searches for the target of the query, and at step 207 prevents a database search for the target of the query when the number of past searches exceeds the maximum number.

As discussed, the number of past searches for the target of the query and the maximum number of searches for the target of the query may be determined by accessing a database 104. Additionally, contacts may be notified when a search for the target is prevented.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a graphical user interface configured to output a search query for searching a database of a plurality of subjects and associated data, wherein the search query identifies a particular subject of the plurality of subjects as a target of the query; and
logic circuitry configured to:
receive the search query and the target of the query;
determine a number of past searches for the target of the query;
determine a maximum number of searches for the target of the query; and
prevent a search of the database for the target of the query when the number of past searches exceeds the maximum number.

2. The apparatus of claim further comprising:
a search history database comprising the number of past searches for the target of the query and the maximum number of searches for the target of the query; and
wherein the logic circuitry is configured to determine the number of past searches for the target of the query and the maximum number of searches for the target of the query by accessing the search history database.

3. The apparatus of claim wherein the search history database also comprises data identifying one or more individuals excluded from any search restrictions for a second subject of the plurality of subjects, and wherein the logic circuitry is further configured to:
receive a second search query identifying the second subject as a target of the second query;
determine that the second search query was provided by one of the one or more individuals excluded from any search restrictions for the second subject and
allow a search of the database for the target of the second query even when a number of past searches for the target of the second query exceeds a maximum number of searches for the target of the second query.

4. The apparatus of claim 2, wherein the search history database also comprises data identifying one or more contacts for the particular subject identified by the target of the query, and wherein the logic circuitry is further configured to:
based on preventing the search of the database for the target of the query, (i) determine the one or more contacts for the particular subject identified by the target of the query when the search for the target is prevented and (ii) send a notification to the one or more contacts.

5. The apparatus of claim wherein sending the notification to the one or more contacts comprises
sending an email or text message to the one or more contacts.

6. A method comprising:
receiving a search query for searching a database of a plurality of subjects and associated data, wherein the search query identifies a particular subject of the plurality of subjects as and a target of the query;
determining a number of past searches for the target of the query;
determining a maximum number of searches for the target of the query; and
preventing a search of the database for the target of the query when the number of past searches exceeds the maximum number.

7. The method of claim 6, wherein the number of past searches for the target of the query and the maximum number of searches for the target of the query is determined by accessing a search history database comprising the number of past searches for the target of the query and the maximum number of searches for the target of the query.

8. The method of claim 6, further comprising:
based on preventing the search of the database for the target of the query, (i) determining one or more contacts to notified when the search for the target is prevented and (ii) sending a notification to the one or more contacts.

9. The method of claim 8, wherein sending the notification to the one or more contacts comprises
sending an email or text message to the one or more contacts.

10. The method of claim 6, further comprising:
receiving a second search query identifying a second subject of the plurality of subjects as a target of the second query;
determining that the second search query was provided by one or more individuals excluded from any search restrictions for the second subject; and
allowing a search of the database for the target of the second query even when a number of past searches for the target of the second query exceeds a maximum number of searches for the target of the second query.

11. A non-transitory computer-readable medium having stored thereon program instructions that, when executed by one or more processors, cause a computing device to perform a set of operations comprising:
receiving a search query for searching a database of a plurality of subjects and associated data, wherein the search query identifies a particular subject of the plurality of subjects as a target of the query;
determining a number of past searches for the target of the query;
determining a maximum number of searches for the target of the query; and
preventing a search of the database for the target of the query when the number of past searches exceeds the maximum number.

12. The non-transitory computer-readable medium of claim 11, wherein the number of past searches for the target of the query and the maximum number of searches for the target of the query is determined by accessing a search history database comprising the number of past searches for the target of the query and the maximum number of searches for the target of the query.

13. The non-transitory computer-readable medium of claim 11, the set of operations further comprising:
based on preventing the search of the database for the target of the query, (i) determining one or more contacts to notified when the search for the target is prevented and (ii) sending a notification to the one or more contacts.

14. The non-transitory computer-readable medium of claim 13, wherein sending the notification to the one or more contacts comprises sending an email or text message to the one or more contacts.

15. The non-transitory computer-readable medium of claim 11, the set of operations further comprising:
receiving a second search query identifying a second subject of the plurality of subjects as a target of the second query;
determining that the second search query was provided by one or more individuals excluded from any search restrictions for the second subject; and
allowing a search of the database for the target of the second query even when a number of past searches for the target of the second query exceeds a maximum number of searches for the target of the second query.
